(19) United States
(12) Patent Application Publication
(10) Pub. No.: US 2025/0020786 A1
(43) Pub. Date: Jan. 16, 2025

(54) SENSOR CALIBRATION USING GLOBALLY REFERENCED CONTROL POINTS

(71) Applicant: TORC Robotics, Inc., Blacksburg, VA (US)

(72) Inventors: Andrew ROITHMAYR, Blacksburg, VA (US); Nicholas GIGLIOTTI, Blacksburg, VA (US)

(73) Assignee: TORC Robotics, Inc., Blacksburg, VA (US)

(21) Appl. No.: 18/221,837

(22) Filed: Jul. 13, 2023

(51) Int. Cl. G01S 7/497; G01S 7/40; G01S 13/931; G01S 17/931

(52) U.S. Cl. CPC G01S 7/4972; G01S 7/40; G01S 13/931; G01S 17/931; G01S 13/865; G01S 13/867

(57) ABSTRACT

Disclosed herein include systems and methods for calibrating perception sensors of an automated vehicle using stationary calibration targets and preconfigured geographic information for the calibration targets. A controller of the automated vehicle references map data indicating locations of each calibration target, which is then recorded by the automated vehicle's perception sensors. The automated vehicle is configured to use a corrected geographical position system (GPS) process (e.g., RTK, PPK) to determine positions and orientations of each sensor and/or the automated vehicle. The controller uses these values to generate accurate calibrations of the automated vehicle and the sensors.

### TECHNICAL FIELD

This application generally relates to managing data inputs for automated vehicles. In particular, the application relates to systems and methods for automatically calibrating perception sensors of autonomous vehicles.

### BACKGROUND

Automated vehicles require precisely aligned sensors to perceive aspects the surrounding environment, such as the objects, road curvature, or other vehicles. Precise alignment is particularly important for long-range sensors where a small angular miscalibration could result in a large error far from the sensor. Prior approaches to the calibration and calibration-check processes required multiple, manual, data collection and processing steps, which delay operations and require a large amount of engineer effort.

What is needed is a more efficient and effective means for calibrating sensors of automated vehicles that also calibrates the sensors with high-quality precision.

### SUMMARY

A solution includes situating specially designed, stationary calibration targets in front of sensors of an automated vehicle. Controllers (or other types of processor devices) of the sensors use these calibration targets for automated sensor calibration processes, generally by referencing a preconfigured expected (known) value for adjusting a sensor's observed value, thereby calibrating the sensor. For some embodiments disclosed herein, an administrator arranges a plurality of calibration targets at various points surrounding the automated vehicle, forming a “target jungle.” Each sensor captures one or more observed values for one or more calibration targets and the controller calibrates the sensor by adjusting the observed value using one or more corresponding expected values.

Target jungles are not always available or practicable. For instance, target jungles require a complex permanent setup, requiring significant effort to build and teardown many calibration targets. Not every owner or operator have the available time, space, or labor force to standup a target jungle. Moreover, not every owner or operator can establish target jungles at every potential location where the automated vehicles will operate. An alternative to target jungles includes establishing geographic information associated with each calibration target in the corresponding expected value(s) of the calibration target.

Accordingly, for certain embodiments disclosed herein include systems and methods for calibrating automated vehicle sensors using one or more stationary calibration targets and preconfigured geographic information associated with each calibration target. A controller (or similar processor device) of the automated vehicle references specific, preprogramed map data indicating a location of the calibration target, as a defined by accurately surveyed, globally referenced location, which is then recorded by the automated vehicle's perception sensors (e.g., LIDAR, camera, radar). The automated vehicle is configured to use a corrected geographical position system (GPS) process (e.g., RTK and/or PPK) to determine the positions and orientations of the sensors and/or the automated vehicle. Using these values, accurate calibrations of the automated vehicle and/or the sensors can be obtained without the requirement for extensive setups or engineer time, or without the setup required for a target jungle.

In an embodiment, a method comprises detecting, by a perception sensor of an automated vehicle, a calibration target; generating, by the perception sensor, position information for the calibration target, the position information including a predicted position of the calibration target relative to the perception sensor; generating, by a processor, a position correction of the sensor based upon comparing the predicted position of the calibration target against an expected location of the calibration target indicated by preconfigured location data; calculating, by the processor, a sensor offset and a sensor orientation for the sensor using the position correction and the predicted position of the calibration target; and updating, by the processor, one or more calibrated settings for the sensor using at least one of the sensor offset, sensor orientation, the position correction, the predicted position, or the expected location.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views. The accompanying drawings, which are incorporated in and constitute a part of this specification, illustrate various exemplary embodiments and together with the description, serve to explain the principles of the disclosed embodiments.

FIG. 1 is a bird's eye view of a roadway including a schematic representation of a vehicle and aspects of an autonomy system of the vehicle, according to an embodiment.

FIG. 2 is a schematic of the autonomy system of the vehicle, according to an embodiment.

FIG. 3 shows a calibration environment in which an autonomy system of an automated vehicle performs calibration operations using an array of fixed calibration targets, according to an embodiment.

FIGS. 4A-4B shows a calibration environment in which an autonomy system of an automated vehicle performs calibration operations using an array of fixed calibration targets, according to an embodiment. FIG. 4A is a side view of the calibration environment. FIG. 4B is a top view of the calibration environment.

FIG. 5 shows a “real world” roadway environment in which an autonomy an automated vehicle performs calibration operations on-the-fly using a roadside calibration target, according to an embodiment.

FIG. 6 shows operations of a method for calibrating sensors of an automated vehicle, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments described herein relate to automated vehicles, such as an automated vehicle having an autonomy system. The autonomy system of an automated vehicle may be completely autonomous (fully-autonomous), such as self-driving, driverless, or Level 4 autonomy, or semi-autonomous, such as Level 3 autonomy. As used herein the term “autonomous” includes both fully-autonomous and semi-autonomous. The present disclosure sometimes refers to automated vehicles as ego vehicles. The autonomy system may be structured on at least three aspects of technology: (1) perception, (2) maps/localization, and (3) behaviors planning and control. The function of the perception aspect is to sense an environment surrounding the automated vehicle and interpret it. To interpret the surrounding environment, a perception module or engine in the autonomy system of the automated vehicle may identify and classify objects or groups of objects in the environment. For example, a perception module associated with various sensors (e.g., LiDAR, camera, radar, etc.) of the autonomy system may identify one or more objects (e.g., pedestrians, vehicles, debris, etc.) and features of the roadway (e.g., lane lines) around the automated vehicle, and classify the objects in the road distinctly.

The maps/localization aspect of the autonomy system may be configured to determine where on a pre-established digital map the automated vehicle is currently located. One way to do this is to sense the environment surrounding the automated vehicle (e.g., via the perception system) and to correlate features of the sensed environment with details (e.g., digital representations of the features of the sensed environment) on the digital map.

Once the systems on the automated vehicle have determined its location with respect to the digital map features (e.g., location on the roadway, upcoming intersections, road signs, etc.), the automated vehicle can plan and execute maneuvers and/or routes with respect to the features of the digital map. The behaviors, planning, and control aspects of the autonomy system may be configured to make decisions about how the automated vehicle should move through the environment to get to its goal or destination. It may consume information from the perception and maps/localization modules to know where it is relative to the surrounding environment and what other objects and traffic actors are doing.

Embodiments disclosed herein include systems and methods for calibrating perception sensors of an automated vehicle. A perception sensor detects a calibration sensor having one or more reflective surface targets detectable to the type of sensor. A controller or similar processor device of the automated vehicle determines an observer (or predicted) position information for the sensor, the automated vehicle, and/or the calibration target using the sensor's inputs. The controller calibrates the perception sensor based upon comparing the predicted position information gathered by the perception sensor against preconfigured (or expected) position information or geolocation information for the target.

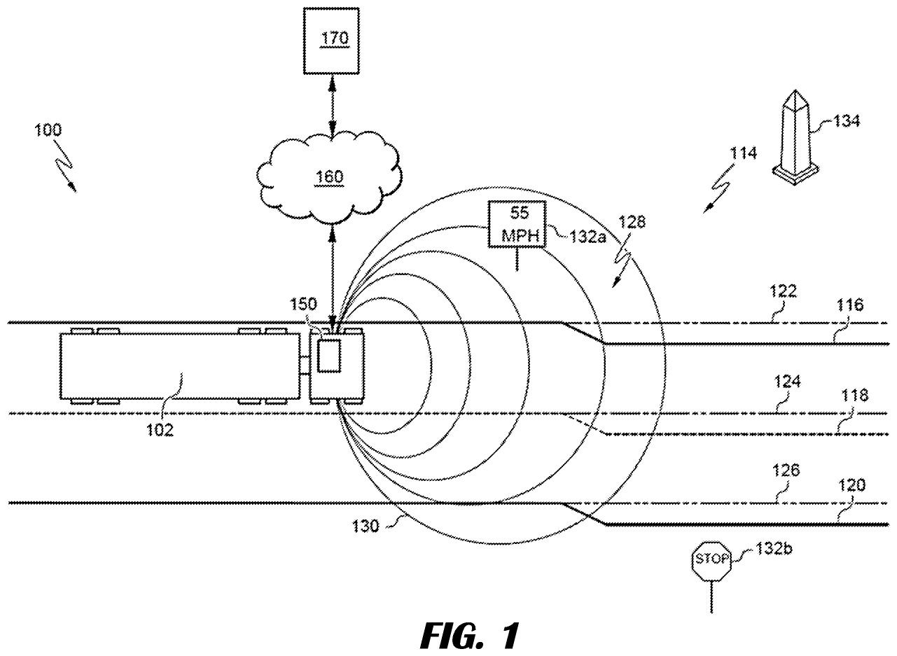

FIG. 1 is a bird's eye view of a roadway environment 100 including a schematic representation of an automated vehicle (shown as an autonomous truck 102) and aspects of an autonomy system 150 of the autonomous truck 102, according to an embodiment. The roadway environment 100 includes various objects located at or nearby a road 114 of the roadway environment 100 and characteristics of the road 114, such as lane lines 116, 118, 120 and a bend 128 in the road 114. The objects include the autonomous truck 102 (sometimes referred to as an “ego” or “ego vehicle”), road signs 132a, 132b and the landmark 134.

Moreover, FIG. 1 shows aspects of the autonomy system 150 of the autonomous truck 102 for modifying one or more actions of truck 102. The truck 102 includes hardware and software components allowing the autonomy system 150 to communicate wirelessly with a remote server 170 via one or more networks 160. The truck 102 and autonomy system 150 need not necessarily connect with the network 160 or server 170 while in operation (e.g., driving down the roadway). The server 170 is remotely situated from the truck 102 (e.g., not at the truck 102), and the truck 102 may deploy with all the necessary perception, localization, and vehicle control software and data necessary to complete its mission fully-autonomously or semi-autonomously.

While this disclosure refers to the autonomous truck 102 (e.g., a tractor trailer) as the automated vehicle, it is understood that the truck 102 could be any type of vehicle including an automobile, a mobile industrial machine, etc. While the disclosure will discuss a self-driving or driverless autonomous system, it is understood that the autonomous system could alternatively be semi-autonomous having varying degrees of autonomy or autonomous functionality.

The autonomy system 150 may be structured on at least three aspects of technology: (1) perception, (2) maps/localization, and (3) behaviors planning and control. The function of the perception aspect is to sense an environment surrounding truck 102 and interpret it. To interpret the surrounding environment, a perception module or engine in the autonomy system 150 of the truck 102 may identify and classify objects or groups of objects in the environment. For example, a perception module associated with various sensors (e.g., LiDAR, camera, radar, etc.) of the autonomy system 150 may identify one or more objects (e.g., pedestrians, vehicles, debris, etc.) and features of the roadway (e.g., lane lines) around truck 102, and classify the objects in the road distinctly.

The maps/localization aspect of the autonomy system 150 may be configured to determine where on a pre-established digital map the truck 102 is currently located. One way to do this is to sense the environment surrounding the truck 102 (e.g., via the perception system) and to correlate features of the sensed environment with details (e.g., digital representations of the features of the sensed environment) on the digital map.

After the autonomy system 150 determine the location of the truck 102 with respect to the digital map features (e.g., location on the road 114, upcoming intersections, road signs 132, etc.), the autonomy system 150 can plan and execute maneuvers and/or routes with respect to the features of the digital map. The behaviors, planning, and control aspects of the autonomy system 150 may be configured to make decisions about how the truck 102 should move through the environment 100 to get to a goal or destination. It may consume information from the perception and maps/localization modules to know where it is relative to the surrounding environment and what other objects and traffic actors are doing.

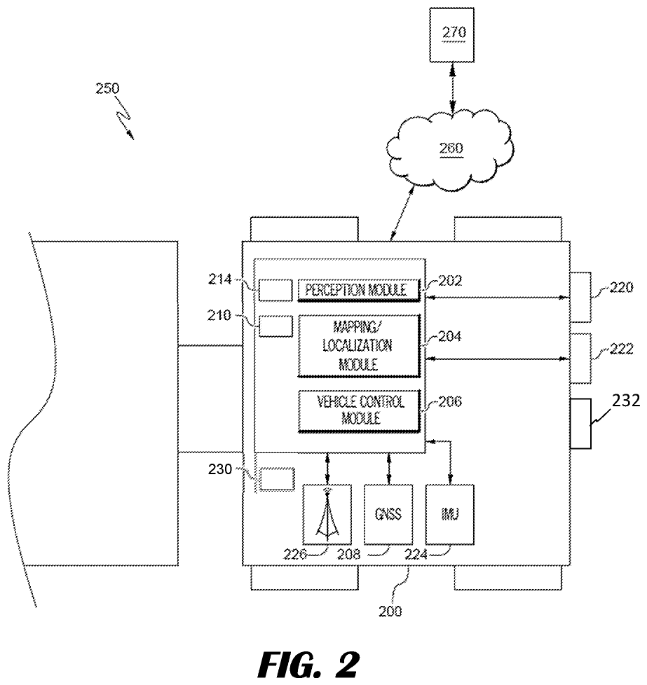

FIG. 2 is a schematic of the autonomy system 250 of an automated vehicle, such as an autonomous truck 200 (e.g., autonomous truck 102 in FIG. 1), according to an embodiment. The autonomy system 250 may include hardware and software components for a perception system, including a camera system 220, a LiDAR system 222, a radar system 232, a GNSS receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. Embodiments of the autonomy system 250 may include more, fewer, or different components or systems, and each of the components or system(s) may include more, fewer, or different components. Additionally, the systems and components shown may be combined or divided in various ways. As show in FIG. 1, the perception systems aboard the automated vehicle may help the truck 102 perceive its environment out to a perception radius 130. The actions of the truck 102 may depend on the extent of perception radius 130.

The camera system 220 of the perception system may include one or more cameras mounted at any location on the truck 200, which may be configured to capture images of the environment surrounding the truck 200 in any aspect or field of view (FOV). The FOV can have any angle or aspect such that images of the areas ahead of, to the side, and behind the truck 102 may be captured. In some embodiments, the FOV may be limited to particular areas around the truck 102 (e.g., forward of the truck 200) or may surround 360 degrees of the truck 200. In some embodiments, the image data generated by the camera system(s) 220 may be sent to the perception module 202 and stored, for example, in memory 214. In some embodiments, the image data generated by the camera system(s) 220, as well as any classification data or object detection data (e.g., bounding boxes, estimated distance information, velocity information, mass information, etc.) generated by the object tracking and classification module 230, can be transmitted to the remote server 270 for additional processing (e.g., correction of detected misclassifications from the image data, training of artificial intelligence models, etc.).

The LiDAR system 222 may include a laser generator and a detector and can send and receive a LiDAR signals. The LiDAR signal can be emitted to and received from any direction such that LiDAR point clouds (or “LiDAR images”) of the areas ahead of, to the side, and behind the truck 200 can be captured and stored as LiDAR point clouds. In some embodiments, the truck 200 may include multiple LiDAR systems and point cloud data from the multiple systems may be stitched together. In some embodiments, the system inputs from the camera system 220 and the LiDAR system 222 may be fused (e.g., in the perception module 202). The LiDAR system 222 may include one or more actuators to modify a position and/or orientation of the LiDAR system 222 or components thereof. The LIDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud and the point cloud may be rendered to visualize the environment surrounding the truck 200 (or object(s) therein). In some embodiments, the point cloud may be rendered as one or more polygon(s) or mesh model(s) through, for example, surface reconstruction. Collectively, the LiDAR system 222 and the camera system 220 may be referred to herein as “imaging systems.”

The radar system 232 may estimate strength or effective mass of an object, as objects made out of paper or plastic may be weakly detected. The radar system 232 may be based on 24 GHZ, 77 GHz, or other frequency radio waves. The radar system 232 may include short-range radar (SRR), mid-range radar (MRR), or long-range radar (LRR). One or more sensors may emit radio waves, and a processor processes received reflected data (e.g., raw radar sensor data).

The GNSS receiver 208 may be positioned on the truck 200 and may be configured to determine a location of the truck 200 via GNSS data, as described herein. The GNSS receiver 208 may be configured to receive one or more signals from a global navigation satellite system (GNSS) (e.g., GPS system) to localize the truck 200 via geolocation. The GNSS receiver 208 may provide an input to and otherwise communicate with mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network.

The IMU 224 may be an electronic device that measures and reports one or more features regarding the motion of the truck 200. For example, the IMU 224 may measure a velocity, acceleration, angular rate, and or an orientation of the truck 200 or one or more of its individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204, to help determine a real-time location of the truck 200, and predict a location of the truck 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5G). In some embodiments, the transceiver 226 may be configured to communicate with external network(s) via a wired connection, such as, for example, during initial installation, testing, or service of the autonomy system 250 of the truck 200. A wired/wireless connection may be used to download, via the one or more networks 260, and install various lines of code in the form of digital files (e.g., HD digital maps), executable programs (e.g., navigation programs), and other computer-readable code that may be used by the system 250 to navigate the truck 200 or otherwise operate the truck 200, either fully-autonomously or semi-autonomously. The digital files, executable programs, and other computer readable code may be stored locally or remotely and may be routinely updated (e.g., automatically or manually) via the transceiver 226 or updated on demand.

In some embodiments, the truck 200 may not be in constant communication with the network 260 and updates which would otherwise be sent from the network 260 to the truck 200 may be stored at the network 260 until such time as the network connection is restored. In some embodiments, the truck 200 may deploy with all of the data and software it needs to complete a mission (e.g., necessary perception, localization, and mission planning data) and may not utilize any connection to network 260 during some or the entire mission. Additionally, the truck 200 may send updates to the network 260 (e.g., regarding unknown or newly detected features in the environment as detected by perception systems) using the transceiver 226. For example, when the truck 200 detects differences in the perceived environment with the features on a digital map, the truck 200 may update the network 260 with information, as described in greater detail herein.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. Autonomy system 250 may include a single microprocessor or multiple microprocessors that may include means for identifying and reacting to differences between features in the perceived environment and features of the maps stored on the truck 200. Numerous commercially available microprocessors can be configured to perform the functions of the autonomy system 250. It should be appreciated that autonomy system 250 could include a general machine controller capable of controlling numerous other machine functions. Alternatively, a special-purpose machine controller could be provided. Further, the autonomy system 250, or portions thereof, may be located remote from the system 250. For example, one or more features of the mapping/localization module 204 could be located remote of truck. Various other known circuits may be associated with the autonomy system 250, including signal-conditioning circuitry, communication circuitry, actuation circuitry, and other appropriate circuitry.

The memory 214 of autonomy system 250 may store data and/or software routines that may assist the autonomy system 250 in performing its functions, such as the functions of the perception module 202, the mapping/localization module 204, the vehicle control module 206, an object-tracking and classification module 230. Further, the memory 214 may also store data received from various inputs associated with the autonomy system 250, such as perception data from the perception system. For example, the memory 214 may store image data generated by the camera system(s) 220, as well as any classification data or object detection data (e.g., bounding boxes, estimated distance information, velocity information, mass information, etc.) generated by the object tracking and classification module 230.

As noted above, perception module 202 may receive input from the various sensors, such as camera system 220, LiDAR system 222, GNSS receiver 208, and/or IMU 224 (collectively “perception data”) to sense an environment surrounding the truck and interpret it. To interpret the surrounding environment, the perception module 202 (or “perception engine”) may identify and classify objects or groups of objects in the environment. For example, the truck 202 may use the perception module 202 to identify one or more objects (e.g., pedestrians, vehicles, debris, etc.) or features of the roadway (e.g., intersections, road signs, lane lines, etc.) before or beside a vehicle and classify the objects in the road. In some embodiments, the perception module 202 may include an image classification function and/or a computer vision function. In some implementations, the perception module 202 may include, communicate with, or otherwise utilize the object tracking and classification module 230 to perform object detection and classification operations.

The perception system may collect perception data. The perception data may represent the perceived environment surrounding the vehicle, for example, and may be collected using aspects of the perception system described herein. The perception data can come from, for example, one or more of the LiDAR system 220, the camera system, and various other externally-facing sensors and systems on board the vehicle (e.g., the GNSS receiver, etc.). For example, on vehicles having a sonar or radar system, the sonar and/or radar systems may collect perception data. As the truck 200 travels along the roadway, the system 250 may continually receive data from the various components of the system 250 and the truck 200. The system 250 may receive data periodically and/or continuously.

With respect to FIG. 1, the truck 102 may collect perception data that indicates presence of the lane lines 116, 118, 120. Features perceived by the vehicle should generally track with one or more features stored in a digital map (e.g., in the mapping/localization module 204). Indeed, with respect to FIG. 1, the lane lines that are detected before the truck 102 is capable of detecting the bend 128 in the road (that is, the lane lines that are detected and correlated with a known, mapped feature) will generally match with features in stored map and the vehicle will continue to operate in a normal fashion (e.g., driving forward in the left lane of the roadway or per other local road rules). However, in the depicted scenario, the vehicle approaches a new bend 128 in the road 114 that is not stored in any of the digital maps onboard the truck 102 because the lane lines 116, 118, 120 have shifted right from their original positions 122, 124, 126.

The system 150 may compare the collected perception data with stored data. For example, the system 150 may identify and classify various features detected in the collected perception data from the environment 100 with the features stored in a digital map. For example, the detection systems of the system 150 may detect the lane lines 116, 118, 120 and may compare the detected lane lines 116, 118, 120 with stored lane lines stored in a digital map.

Additionally, the detection systems of the system 150 could detect the road signs 132a, 132b and the landmark 134 to compare such features with features in a digital map. The features may be stored as points (e.g., signs, small landmarks, etc.), lines (e.g., lane lines 116, 118, 120, edges of the road 114), or polygons (e.g., lakes, large landmarks 134) and may have various properties (e.g., style, visible range, refresh rate, etc.), which properties may control how the system 150 interacts with the various features. Based on the comparison of the detected features with the features stored in the digital map(s), the system 150 may generate a confidence level, which may represent a confidence of the truck 100 in a location with respect to the features on a digital map and hence, an actual location of the truck 100.

With reference to FIG. 2, the image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module (e.g., the object detection and classification module 230) that may be communicatively coupled to a repository of images or image data (e.g., visual data and/or point cloud data) which may be used to detect and classify objects and/or features in real time image data captured by, for example, the camera system 220 and the LiDAR system 222. In some embodiments, the image classification function may be configured to detect and classify features based on information received from only a portion of the multiple available sources. For example, in the case that the captured visual camera data includes images that may be blurred, the system 250 may identify objects based on data from one or more of the other systems (e.g., LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the truck 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of its motion, size). The computer vision function may be embodied by a software module (e.g., the object detection and classification module 230) that may be communicatively coupled to a repository of images or image data (e.g., visual data; point cloud data), and may additionally implement the functionality of the image classification function.

Mapping/localization module 204 receives perception data that can be compared to one or more digital maps stored in the mapping/localization module 204 to determine where the truck 200 is in the world and/or or where the truck 200 is on the digital map(s). In particular, the mapping/localization module 204 may receive perception data from the perception module 202 and/or from the various sensors sensing the environment surrounding the truck 200, and may correlate features of the sensed environment with details (e.g., digital representations of the features of the sensed environment) on the one or more digital maps. The digital map may have various levels of detail and can be, for example, a raster map, a vector map, etc. The digital maps may be stored locally on the truck 200 and/or stored and accessed remotely. In at least one embodiment, the truck 200 deploys with sufficiently stored information in one or more digital map files to complete a mission without connection to an external network during the mission. A centralized mapping system may be accessible via network 260 for updating the digital map(s) of the mapping/localization module 204. The digital map may be built through repeated observations of the operating environment using the truck 200 and/or trucks or other vehicles with similar functionality. For instance, the truck 200, a specialized mapping vehicle, a standard automated vehicle, or another vehicle, can run a route several times and collect the location of all targeted map features relative to the position of the vehicle conducting the map generation and correlation. These repeated observations can be averaged together in a known way to produce a highly accurate, high-fidelity digital map. This generated digital map can be provided to each vehicle (e.g., from the network 260 to the truck 200) before the vehicle departs on its mission so it can carry it onboard and use it within its mapping/localization module 204. Hence, the truck 200 and other vehicles (e.g., a fleet of trucks similar to the truck 200) can generate, maintain (e.g., update), and use their own generated maps when conducting a mission.

The generated digital map may include an assigned confidence score assigned to all or some of the individual digital feature representing a feature in the real world. The confidence score may be meant to express the level of confidence that the position of the element reflects the real-time position of that element in the current physical environment. Upon map creation, after appropriate verification of the map (e.g., running a similar route multiple times such that a given feature is detected, classified, and localized multiple times), the confidence score of each element will be very high, possibly the highest possible score within permissible bounds.

The vehicle control module 206 may control the behavior and maneuvers of the truck. For example, once the systems on the truck have determined its location with respect to map features (e.g., intersections, road signs, lane lines, etc.) the truck may use the vehicle control module 206 and its associated systems to plan and execute maneuvers and/or routes with respect to the features of the environment. The vehicle control module 206 may make decisions about how the truck will move through the environment to get to its goal or destination as it completes its mission. The vehicle control module 206 may consume information from the perception module 202 and the maps/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the truck and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the truck. The steering system may be any combination of mechanisms configured to adjust the heading or direction of the truck. The brake system may be, for example, any combination of mechanisms configured to decelerate the truck (e.g., friction braking system, regenerative braking system). The vehicle control module 206 may be configured to avoid obstacles in the environment surrounding the truck and may be configured to use one or more system inputs to identify, evaluate, and modify a vehicle trajectory. The vehicle control module 206 is depicted as a single module, but can be any combination of software agents and/or hardware modules able to generate vehicle control signals operative to monitor systems and control various vehicle actuators. The vehicle control module 206 may include a steering controller and for vehicle lateral motion control and a propulsion and braking controller for vehicle longitudinal motion.

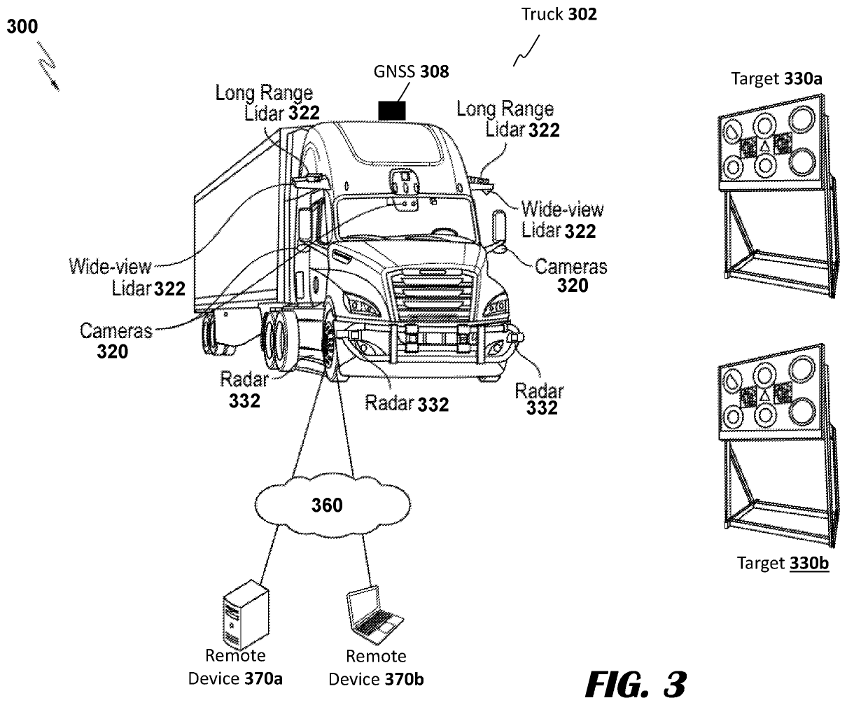

FIG. 3 shows an environment 300 in which an autonomy system (not shown) of an automated vehicle (shown as a truck 302) performs calibration operations using any number of surveyed ground points marked with calibration targets 330a-330b (generally referred to as a target 330 or targets 330).

The truck 302 is equipped with one or more perception sensors, such as LIDAR 322 (e.g., long range LIDAR, wide-view LIDAR), radar 332, and cameras 320, among other types of perception sensors. The truck 302 is further equipped with a global navigation satellite system (GNSS) that captures geolocation data (e.g., GPS data, map data) and is further capable of high precision corrections, such as Real-Time Kinematic (RTK) or Post-Processed Kinematic (PPK) corrections.

The physical placement of a particular calibration target 330 geographically marks a corresponding preconfigured and surveyed ground-point. The calibration target 330 includes one or more a surface having various features (e.g., shape, color, reflectivity, height-from-ground) detectable to one or more types (or modality) of sensors 320, 322, 332. The surface of the calibration target 330 may include one or more surface targets having the various features (e.g., shape, color, reflectivity, height-from-ground). As an example, as shown in FIG. 3, the surface of the calibration target 330 includes eight surface targets, including two square shapes six circles with varied amounts of retro-reflectivity, radar-reflectivity, and/or high-contrast visual appeal. In some cases, the surface target includes information detectable by one or more sensors 320, 322, 332 and recognizable by a controller of the truck 102. As an example, in FIG. 3, the two square shapes contain quick reference (QR) codes that convey certain information to the truck 302.

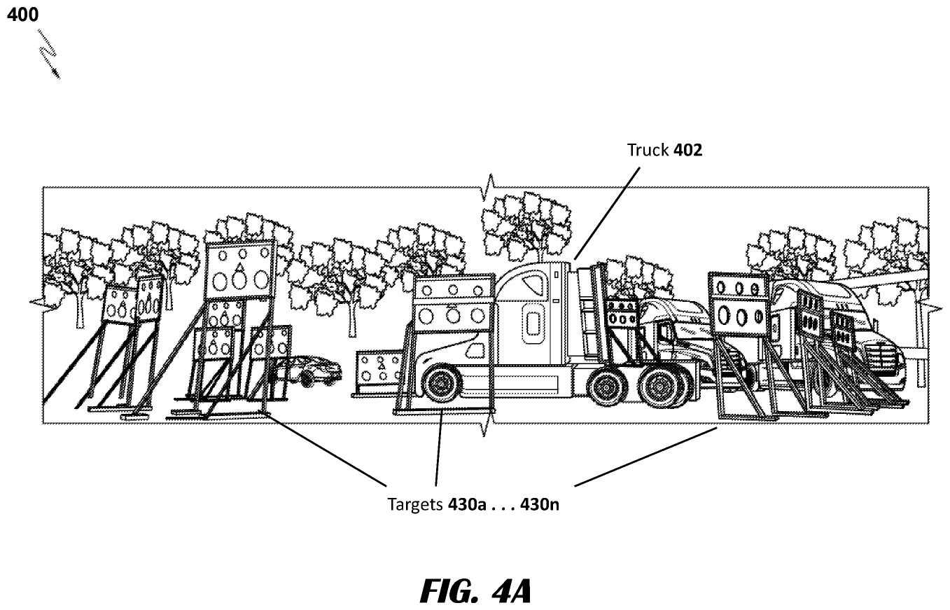

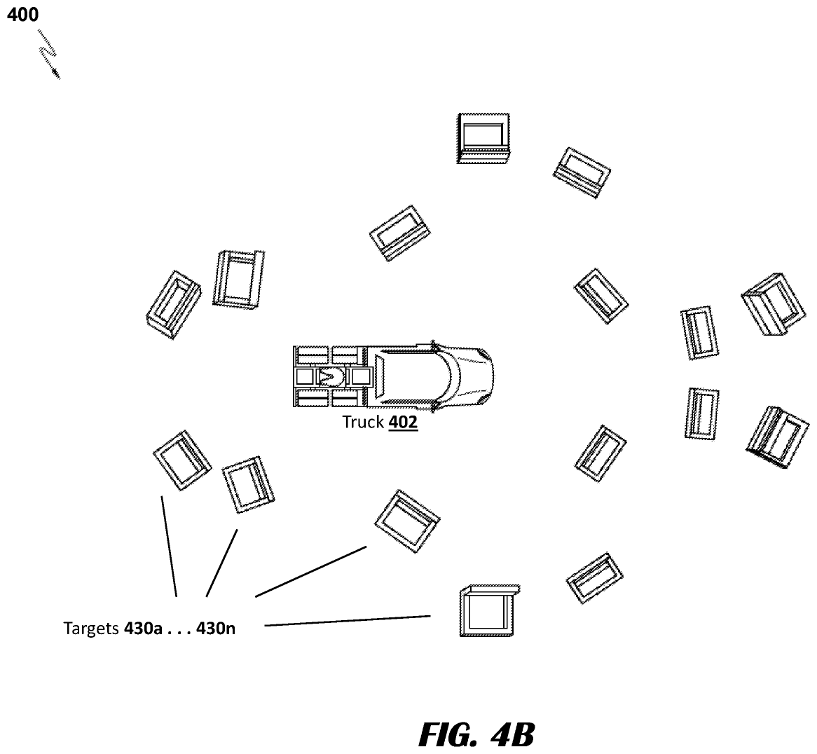

In some embodiments (such as the embodiment in FIGS. 4A-4B), the surveyed ground points include specifically preconfigured locations at an automated vehicle management hub, testing location, or other controlled location. The locations are marked by an array (or “target jungle”) of calibration targets 330. During a specific calibration period, the sensors 320, 322, 332 of the truck 302 detect the targets 330 and record each target's 330 position relative to each sensor 320, 322, 332. The controller of the truck 302 generates a Retro-Reflective Sign (RRS) pipeline in one or more components of an autonomy system (e.g., Map Localizer component). The controller estimates a position of the truck 302 by matching the detected retroreflective surfaces of the targets 330 against known positions stored in map data as a semantic map. This RRS pipeline approach in the these embodiments reference accurate calibrations and known positions to estimate the accurate position of the truck 302, though the RRS pipeline approach need not generate or reference geolocation data (e.g., GPS data, GNSS data) for the targets 330 or truck 302.

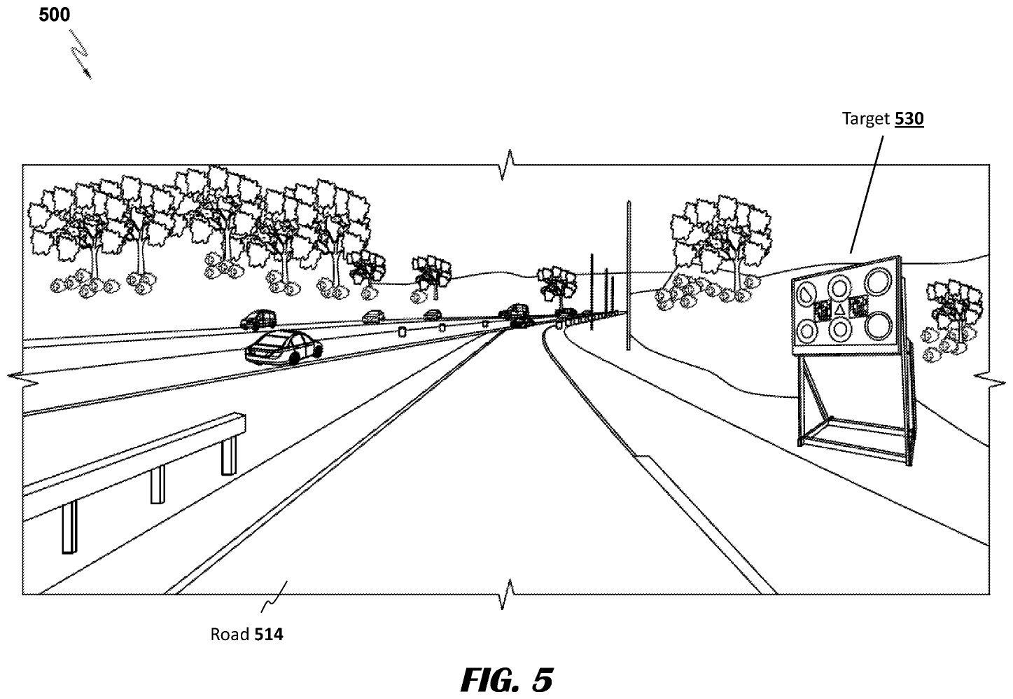

Additionally or alternatively, in some embodiments, the surveyed ground points include existing landmarks, such as retroreflective signs, roadside calibration targets 330, road markers, or other road features in a real-world operating environment (e.g., roadway environment 500), as shown in FIG. 5, which may or may not be managed by an owner or operator of the truck 302. During the specific calibration period or during the regular autonomous operations, the sensors 320, 322, 332 of the truck 302 detect the targets 330 and record each target's 330 position relative to each sensor 320, 322, 332. A controller or other processor of the 302 or remote device 370 executes algorithms that match the measured positions of the targets 330 to locations of the predetermined (pre-surveyed) ground-points, as indicated by a map. The controller generates high-precision corrected position based upon the ground-points indicated by the geolocation in the map data. The controller then calculates an offset and orientation of each sensor 320, 332, 332, relative to the corrected position.

FIGS. 4A-4B show a calibration environment 400 in which an autonomy system (not shown) of an automated vehicle (shown as a truck 402) performs calibration operations using an array of multiple surveyed ground points including any number of fixed calibration targets 430a-430n (generally referred to as “targets 430” or a “target 430”), sometimes referred to as a “target jungle.” FIG. 4A is a side view of the calibration environment 400 having the truck 402 situated amongst the array of the calibration targets 430. Similarly, FIG. 4B is a top view of the calibration environment 400 having the truck 402 situated amongst the array the fixed calibration targets 430.

The surveyed ground points include specifically preconfigured, marked locations (array of calibration targets 430) at an automated vehicle management hub, testing location, or other controlled location. During a specific calibration period, the sensors of the automated vehicle detect the targets 430 and record each target's 430 position relative to each sensor.

When perception components (e.g., perception sensors) of the automated vehicle detect the calibration targets 430, a map localizer component (or other hardware or software component of the automated vehicle) generates a pipeline of Retro-Reflective Signs (RRS's), sometimes referred to as an RRS pipeline. The controller or Map Localizer component matches detected retroreflective surfaces with known positions stored in semantic map data to estimate the vehicle position relative to the targets 430. The RRS pipeline calibration process uses accurate calibrations and known positions to estimate an accurate vehicle position. This approach need not generate, use, or reference geolocation data (e.g., GPS data, GNSS data).

FIG. 5 shows a “real world” roadway environment 500 in which an autonomy system (not shown) of an automated vehicle (e.g., truck 302) performs calibration operations using one or more roadside calibration targets 530 situated, for example, alongside a road 514, allowing the truck to calibrate sensors during real world operation.

A non-transitory machine-readable storage medium contains map data associated surveyed ground points. The storage medium includes, for example, storage locations situated locally at the automated vehicle or at a remote location (e.g., remote server, remote database), which a controller or other processor of the automated vehicle accesses during calibration processes and sensor functions. The survey ground-points correspond to known, expected geolocation points in the map data that the automated vehicle references for sensor calibration operations. The preconfigured and stored map data includes the geolocation information associated with the ground-points marked by real-world objects in the roadway environment 500, such as roadside calibration targets 530, landmarks, retroreflective signs, road markers, or other road features alongside the road 514 or otherwise in the roadway environment 500.

During the specific calibration period or during the regular autonomous operations, one or more sensors of the automated vehicle detect the target 530 and record a target position into the storage memory, where the target position indicates a position of the target 530 relative to each sensor and/or relative to the automated vehicle. The controller of the automated vehicle executes algorithms that match the measured target positions against an expected target location of the predetermined (pre-surveyed) ground-points, as indicated by the map data. The controller generates high-precision corrected position based upon the ground-points indicated by the geolocation in the map data and/or data received from a GNSS instrument of the automated vehicle. The controller then calculates an offset and orientation (or other position-related information) of each sensor and/or the automated vehicle, relative to the corrected position.

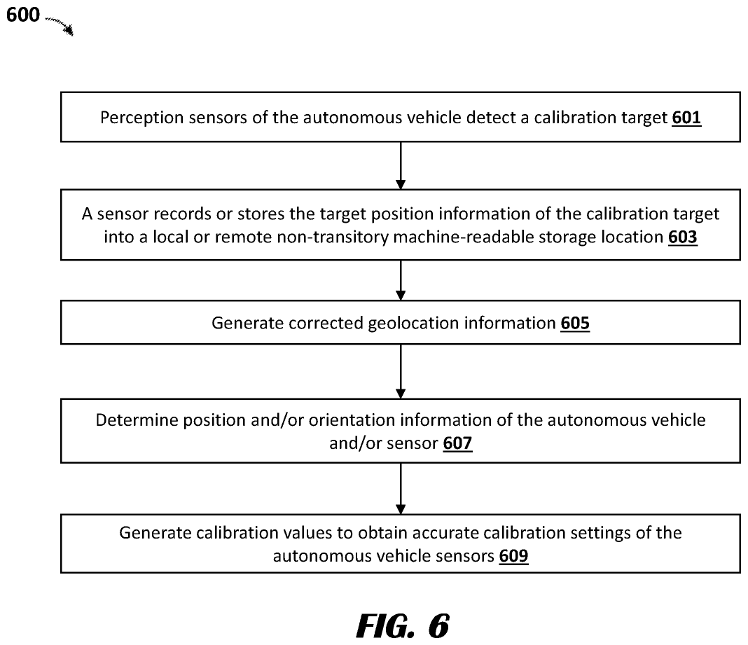

FIG. 6 shows operations of a method 600 for calibrating sensors of an automated vehicle. The method 600 uses specific ground-points defined by preconfigured surveyed, globally referenced geolocations as known expected information for calibrating the sensors of the automated vehicle.

In operation 601, one or more perception sensors of the automated vehicle detect a calibration target. The calibration includes one or more surface targets having surface characteristics detectable by the sensors. The sensor then generates various types of information about the target, such as position information indicating a predicted position of the sensor relative to the sensor.

In operation 603, the sensor records or stores the target position information of the calibration target into a local or remote non-transitory machine-readable storage location. In some cases, a controller or other processor device of the automated vehicle instructs a GNSS to determine a vehicle geolocation (e.g., GPS information) of the automated vehicle and/or the sensor.

In operation 605, using the target position information, the controller or processor of the automated vehicle generates corrected geolocation information according to RTK and/or PPK processes. The processor of the automated vehicle queries map data indicating expected target geolocations and stored in the local or remote storage location. The controller executes algorithms that match the measured target positions against the map data of pre-surveyed points indicating the expected locations of the calibration target. The controller uses the comparison to determine the corrected location or position information.

In operation 607, the controller determines position and/or orientation information (sometimes referred to as “position” or “positioning information” for ease of description) of the automated vehicle and/or sensor. For instance, the controller calculates a position offset and orientation of each sensor relative to the corrected position or location of the automated vehicle or sensor. Using the corrected GPS information (e.g., RTK and/or PPK data), the controller determines, for example, the positioning of a particular sensor, the positioning of the automated vehicle, or the positioning information the calibration target, among other features of an operating environment (e.g., roadway environment; calibration environment).

In operation 609, the controller generates calibration values to obtain accurate calibration settings of the automated vehicle sensors. In some cases, the controller compares the calculated calibration values against existing calibration settings values for the sensor and generates a warning notification in response to determining that the existing calibration settings are mis-calibrated, in response to determining that the differences fails to satisfy a calibration threshold. The warning notification indicates, for example, the sensor is mis-calibrated, imprecise, inaccurate. In some cases, the warning notification configures vehicle software to operate with reduced accuracy or directly applies the updates to the vehicle according to the calibration values.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
detecting, by a perception sensor of an automated vehicle, a calibration target;
generating, by the perception sensor, position information for the calibration target, the position information including a predicted position of the calibration target relative to the perception sensor;
generating, by a processor, a position correction of the sensor based upon comparing the predicted position of the calibration target against an expected location of the calibration target indicated by preconfigured location data;
calculating, by the processor, a sensor offset and a sensor orientation for the sensor using the position correction and the predicted position of the calibration target; and
updating, by the processor, one or more calibrated settings for the sensor using at least one of the sensor offset, sensor orientation, the position correction, the predicted position, or the expected location.

2. The method according to claim 1, wherein updating the one or more calibrated settings includes storing, by the processor, the one or more calibrated settings for the sensor into a non-transitory memory.

3. The method according to claim 1, further comprising:
generating, by the processor, a predicted vehicle position relative to each calibration target of one or more calibration targets; and
calculating, by the processor, a vehicle position for the automated vehicle using the position correction generated for each sensor of one or more sensors of the automated vehicle and the predicted vehicle position.

4. The method according to claim 1, wherein updating the one or more calibrated settings includes updating, by the processor, a vehicle location for the automated vehicle in the one or more calibrated settings.

5. The method according to claim 1, identifying, by the processor, that the sensor is miscalibrated in response to determining that a difference between the predicted position of the sensor and the sensor offset fails a calibration threshold.

6. The method according to claim 1, further comprising generating, by the processor, a notification indicating an amount of calibration correction for the sensor based upon the at least one of the sensor offset, the sensor orientation, the position correction, the predicted position, or the expected location.

7. The method according to claim 1, wherein generating the position correction of the sensor includes querying, by the processor, map data indicating the expected location for the calibration target, the map data stored in non-transitory memory in communication with the processor.

8. The method according to claim 7, wherein the non-transitory memory containing the map data is situated at the automated vehicle.

9. The method according to claim 7, wherein the non-transitory memory containing the map data is situated at a remote computing device in networked communication with the processor of the automated vehicle.
